(19) United States
(12) Patent Application Publication
(10) Pub. No.: US 2018/0217796 A1
(43) Pub. Date: Aug. 2, 2018

(54) PRINT APPARATUS AND MEMORY MANAGING METHOD FOR PRINT APPARATUS

(71) Applicant: SEIKO EPSON CORPORATION, Tokyo (JP)

(72) Inventor: Satoshi KOTAKA, Azumino (JP)

(21) Appl. No.: 15/883,952

(22) Filed: Jan. 30, 2018

(30) Foreign Application Priority Data
Feb. 1, 2017 (JP) 2017-016533

(51) Int. Cl. G06F 3/12; H04N 1/00

(52) U.S. Cl. CPC G06F 3/1267; G06F 3/1296; H04N 2201/0094; H04N 1/00244; G06F 3/1285

(57) ABSTRACT

A print apparatus includes a memory region to be used for a print job and a memory management unit. At start-up, the memory management unit allocates, to the memory region, an external job-dedicated region to be used for an external job and not to be used for a local job, and allocates a common region to the other region of the memory region. The external job-dedicated region is extended by a predetermined size when printing stops, and is reduced to an original size when printing restarts. A use region for the external job is allocated to the common region if the common region has a free space, and is allocated to the external job-dedicated region if the common region has no free space. The local job is not allocated to the external job-dedicated region.

### BACKGROUND

### 1. Technical Field

The present invention relates to a print apparatus that performs printing by a direct operation on the print apparatus and printing by communication from an external device, and to a memory managing method for the print apparatus.

### 2. Related Art

Multi function peripherals (MFPs) each having a printer function, a copying function, and a facsimile (FAX) function, for example, have been used. The MFP of this type receives an instruction of, for example, image scanning, copying, or FAX transmission by an “immediate operation” (direct operation) of an operation panel and thereby executes a job corresponding to the operation. The MFP also receives a print job from an external device such as a computer or a FAX machine connected through a network and performs the print job. In this specification, an operation on an MFP by communication from the external device will be referred to as an “online operation,” a print job performed by this online operation will be referred to as an “external job,” a direct operation on the MFP by a user will be referred to as a “local operation,” and a print job performed by the local operation will be referred to as a “local job.”

A process of the print job is performed by using a use region allocated from a memory region for each processing unit. The use region allocated to the print job is released when the process of the print job is finished. In a case where a use region for each processing unit of the print job is allocated to the memory region in the order of reception of execution of the print job, that is, in a first-come-first-served manner, when the memory region is occupied by an external job, execution of a local job is kept waiting in some cases. For example, while a user A is to perform printing by a local operation, when a user B introduces an external job by an online operation, shortage of free memory occurs so that a use region for a local job cannot be allocated to a memory region, and consequently, the user A has to wait until a print job of the user B finishes.

JP-A-2014-23010 discloses control of allocation of use regions for an external job and a local job to a memory region. In an MFP of JP-A-2014-23010, when a local operation is performed, a local job-dedicated region to be used only for the local job is allocated to the memory region. A process of the external job is performed by using a common region that is a part of the memory region excluding the local job-dedicated region therefrom. Thus, a user who has performed the local operation does not have to be kept waiting for completion of the local job without a delay of the process of the external job.

In the control of JP-A-2014-23010, when a large amount of local jobs are accumulated in the memory region, shortage of the common region occurs, so that no external job can be accepted. For example, when printing is suspended because of an error or other reasons, no accumulated print jobs are processed. Thus, the memory region is not released, and print jobs continue to be accumulated. Finally, shortage of a free space occurs in the memory region, and as a result, external jobs cannot be accepted anymore.

Once external jobs cannot be accepted anymore because of the shortage of a free space of the memory, even when a user tries to print an external job prior to a local job by using a print order changing function, the user cannot select the external job as a target of the change because of the failure in accepting external jobs. As a result, no external job as a print job can be executed. When the local job is canceled and a free space is created in the memory region, an external job can be accepted. However, since acceptance of an external job starts after the cancel, it takes time to complete printing. This problem also arises similarly in a case where print jobs are accepted in a first-come-first-served manner.

In a print apparatus having an interruption function, even when shortage of a free space of a memory region occurs, new external job can be introduced to be executed. Such control, however, needs to be installed with a special function (interruption function).

### SUMMARY

An advantage of some aspects of the invention is to propose a print apparatus that can prevent waiting of execution of an eternal job without using a special function such as an interruption function, and a method for controlling the print apparatus.

To solve the problems described above, according to an aspect of the invention, a print apparatus includes a memory region usable for an external job by an online operation and for a local job by a local operation, and a memory management unit that manages allocation of the memory region. The memory management unit includes an external job-dedicated region allocation unit that allocates, to the memory region, an external job-dedicated region to be used for the external job and not to be used for the local job, and a common region allocation unit that allocates a common region to be used for the external job and the local job to a part of the memory region except the external job-dedicated region.

According to another aspect of the invention, a memory managing method for a print apparatus that manages allocation of a memory region usable for an external job by an online operation and a local job by a local operation. The method includes: allocating, to the memory region, an external job-dedicated region to be used for the external job and not to be used for the local job; and allocating a common region to be used for the external job and the local job to a part of the memory region except the external job-dedicated region.

The print apparatus and the memory managing method for the print apparatus according to some aspects of the invention can allocate, to the memory region, the external job-dedicated region to be used for the external job and not to be used for the local job. Thus, even when the local job is accumulated in the memory region and therefore shortage of a free space occurs in the common region, the external job can be accepted. Accordingly, even when a process of a print job is suspended, waiting of execution of the external job can be avoided. For example, since the external job can be selected as a target of change of the print order, the external job as a print job can be executed with priority by changing the print order. In addition, the external job can be accepted before the local job is canceled and a free space is created in the memory region. Thus, when the local job is canceled, the already accepted external job can be immediately executed. As a result, waiting of execution of the external job can be avoided.

It is preferable that, in allocating use regions for the external job and the local job to the memory region, the use region for the external job is allocated to the common region if the common region has a free space, and to the external job-dedicated region if the common region has no free space. The use region for the local job is allocated to the common region and is not allocated to the external job-dedicated region. In this case, no shortage of a free space occurs in the external job-dedicated region before occurrence of shortage of a free space in the common region. Thus, shortage of a free space in the memory region without acceptance of any external job does not occur. As a result, it is possible to avoid waiting of execution of the external job.

It is preferable that, in releasing the use region for the external job or the use region for the local job, if the external job-dedicated region has an allocated use region, a use region to be released is allocated to the external job-dedicated region, and, if the external job-dedicated region has no allocated use region, the use region to be released is allocated to the common region. In this case, the external job-dedicated region can be released with priority, and thus, a free memory size of the external job-dedicated region can be kept as large as possible. As a result, it is possible to avoid waiting of execution of the external job.

It is preferable that a method of allocating the external job-dedicated region to the memory region at start-up may be employed. Alternatively, a method of allocating the external job-dedicated region to the memory region in a case where printing stops in the middle of the printing may be employed. In either case, the external job-dedicated region can be allocated, and thus, waiting of execution of the external job can be avoided. In the case of allocating the external job-dedicated region at start-up, the external job-dedicated region can be obtained from start-up. Thus, it is possible to prevent a failure in allocating the external job-dedicated region at stop of printing. On the other hand, in the case of allocating the external job-dedicated region at stop of printing, the external job-dedicated region is not allocated until printing stops, and thus, waiting of execution of the local job can be avoided.

It is preferable that, in a case where printing stops in a middle of the printing, the external job-dedicated region is extended. Then, when printing stops and processing of a print job is suspended, a new memory region to which the external job can be allocated can be obtained, and thus, the external job can be accepted. As a result, it is possible to avoid waiting of execution of the external job. In addition, in this case, when printing suspended in the middle of the printing restarts, the external job-dedicated region is preferably reduced. In this manner, an unnecessarily large amount of the memory region is not allocated to the external job-dedicated region.

Alternatively, in a case where the external job-dedicated region is allocated at start-up, when printing stops in the middle of the printing, the external job-dedicated region may not be extended. In this case, as long as the external job-dedicated region has been obtained at start-up, waiting of execution of the external job can be avoided.

It is preferable that the method of allocating the external job-dedicated region to the memory region may be one of an at-startup fixing method of allocating the external job-dedicated region at start-up, an at-stop fixing method of allocating the external job-dedicated region when printing stops in the middle of the printing, and an at-stop extension method of allocating the external job-dedicated region at start-up and extending the external job-dedicated region when printing stops in the middle of the printing. In this case, a user can select an allocation method as appropriate depending on an introduction status of the external job and the local job, for example.

A method of allocating the external job-dedicated region of a size in accordance with the size of the memory region may be employed. Alternatively, a method of allocating the external job-dedicated region of a size in accordance with the number of pages of the external job may be employed. A method of allocating the external job-dedicated region of a size in accordance with the number of jobs of the external job may also be employed. Accordingly, the external job-dedicated region may be allocated to an appropriate size. For example, in a case where the memory region is large, the external job-dedicated region can be kept large. In a case where allocation is performed in accordance with the number of pages or jobs, the external job-dedicated region can be allocated in accordance with an introduction status of the external job and the local job.

### BRIEF DESCRIPTION OF THE DRAWINGS

The invention will be described with reference to the accompanying drawings, wherein like numbers reference like elements.

FIG. 1 is an illustration of a schematic configuration and a use status of a print apparatus to which the invention is applied.

FIG. 2 is a functional block diagram of the print apparatus.

FIGS. 3A and 3B are flowcharts of control of allocating a memory region.

FIG. 4 is an illustration of an at-stop extension method.

FIG. 5 is an illustration of a method of allocating a use region to be released.

### DESCRIPTION OF EXEMPLARY EMBODIMENTS

Embodiments of a print apparatus and a memory managing method for the print apparatus to which the invention is applied will be described with reference to the drawings.

### Overall Configuration

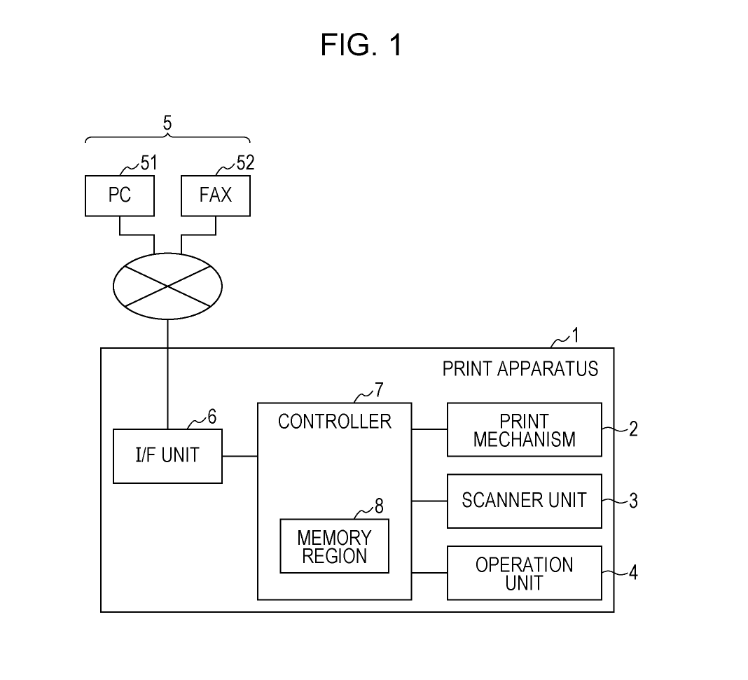

FIG. 1 is an illustration of a schematic configuration and a use status of a print apparatus 1 to which the invention is applied. The print apparatus 1 is an MFP having a print function, a scanner function, and a FAX function, and includes a print mechanism 2 and a scanner unit 3. The print mechanism 2 performs printing by a line ink jet method, but may perform printing by other methods. The print apparatus 1 includes an operation unit 4 for a direct operation (local operation), an I/F unit 6 for performing communication with an external device 5 through a network, and a controller 7. The external device 5 is, for example, a general-purpose personal computer 51 or a FAX machine 52, or may be other devices. The controller 7 includes a memory region 8 to be used for a print job. The operation unit 4 is, for example, a touch panel including a liquid crystal display unit. Alternatively, the operation unit 4 may include other operation sections or display sections. For example, the operation unit 4 may include a switch, an operation key, and an LED lamp.

The controller 7 accepts a direct operation (local operation) to the operation unit 4 and executes a print job (local job). Based on the local operation, the controller 7 executes a job except the print job. For example, the controller 7 performs image scanning by the scanner unit 3 and stores image data. Examples of the local operation for the print job (local job) include a copying operation of performing scanning and printing of a document and an operation of manually receiving FAX data and printing the data. Data accumulated in a memory unit incorporated in the print apparatus 1 or accessible from the print apparatus 1 may be selected as a print target and printed.

The controller 7 receives an external job from the external device 5 through the through I/F unit 6. The controller 7 also transmits and receives FAX data through the I/F unit 6. The controller 7 converts print job data and FAX data generated or received by a local operation or an online operation to print data that can be printed by the print mechanism 2, outputs the print data to the print mechanism 2, and causes the print mechanism 2 to perform printing.

The controller 7 includes a CPU, a RAM that is a volatile memory, and a ROM that is a nonvolatile memory. The controller 7 performs various processes by cooperation of hardware and software, such as a process in which the CPU reads a program such as firmware stored in the RAM or ROM and performs processing. The controller 7 may include an electronic component such as an ASIC and a signal processing circuit, for example, in addition to the CPU. In this case, a process is performed by a function installed in an ASIC, and the signal processing circuit performs signal processing and executes a process, so that various processes according to the invention are performed by cooperation with the CPU, the ASIC, and the signal processing circuit. The controller 7 may include a plurality of CPUs. In this case, the plurality of CPUs perform distributed processing, thereby executing various processes.

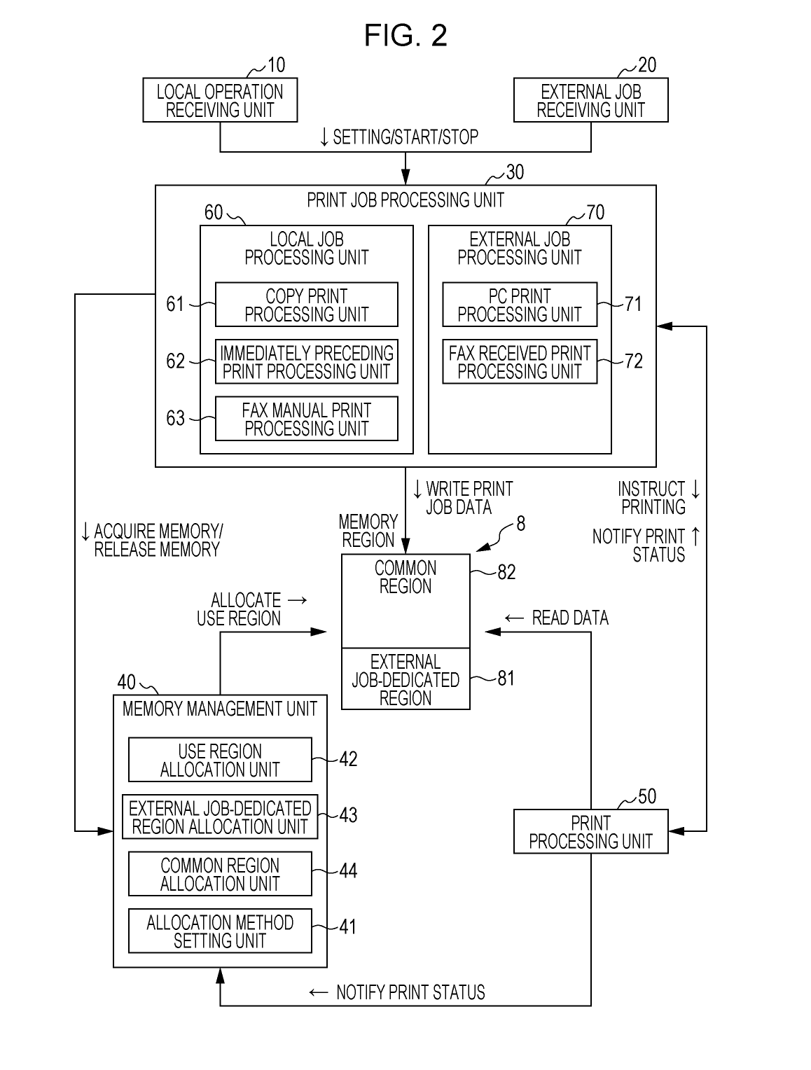

FIG. 2 is a functional block diagram of the print apparatus 1 and illustrates a functional configuration concerning a print job. As illustrated in FIG. 2, the print apparatus 1 includes a local operation receiving unit 10, an external job receiving unit 20, a print job processing unit 30, a memory management unit 40, and a print processing unit 50. These functions are implemented when the controller 7 executes various processes by cooperation of hardware and software.

The local operation receiving unit 10 receives a local operation performed on the operation unit 4 and passes a start command and a stop command of a local job and a setting command regarding the local job to the print job processing unit 30. Specifically, the local operation receiving unit 10 passes a start command of copy printing, a pint command of image data or FAX data, and a FAX manual reception command to the print job processing unit 30. The external job receiving unit 20 receives a start command and a stop command of an external job and a setting command regarding an external job by an online operation from the external device 5, and passes these commands to the print job processing unit 30. Specifically, the external job receiving unit 20 passes a print command of image data or FAX data to the print job processing unit 30.

The print job processing unit 30 includes a local job processing unit 60 and an external job processing unit 70. The local job processing unit 60 includes a copy print processing unit 61, an immediately preceding print processing unit 62, and a FAX manual print processing unit 63. Based on a start command of copy printing, the copy print processing unit 61 controls the scanner unit 3 to perform image scanning of a document. Then, a print job of printing image data generated by image scanning is executed. The immediately preceding print processing unit 62 executes a print job of printing specified image data or FAX data. The FAX manual print processing unit 63 communicates with the FAX machine 52 to receive FAX data, and executes a print job based on the received FAX data.

The external job processing unit 70 includes a PC print processing unit 71 and a FAX received print processing unit 72. The PC print processing unit 71 receives print job data from the personal computer 51 connected to the print apparatus 1 through the network, and executes printing based on the received print job data. The FAX received print processing unit 72 receives FAX data from the FAX machine 52 and executes a print job based on the received FAX data.

In this manner, each part (the copy print processing unit 61, the immediately preceding print processing unit 62, the FAX manual print processing unit 63, the PC print processing unit 71, and the FAX received print processing unit 72) of the print job processing unit 30 executes a corresponding print job (a local job or an external job). In executing the print job, the print job processing unit 30 instructs the memory management unit 40 to acquire a memory region to be used for the print job and writes data in an allocated use region. The print job processing unit 30 instructs the print processing unit 50 to perform printing by using data written in the memory region 8.

The print processing unit 50 reads data from the memory region 8 in accordance with the print instruction from the print job processing unit 30. Then, the print processing unit 50 converts the readout data to print data that can be printed by the print mechanism 2, and causes the print mechanism 2 to execute printing. The print processing unit 50 notifies the print job processing unit 30 and the memory management unit 40 of a print status. For example, a notification of the print status is issued for each processing unit of the print job, so that notification of a printing progress status is issued. When printing stops because of an error such as a paper jam or paper shortage or printing restarts after resolution of the error, the print processing unit 50 notifies the print job processing unit 30 and the memory management unit 40 of this stop or restart.

### Management of Memory Region

The memory management unit 40 receives a memory acquisition command to be used for a print job from the print job processing unit 30 and allocates a use region to be used for the print job to the memory region 8. The memory management unit 40 allocates a use region for each processing unit of the print job. For example, allocation of a use region is performed on each page. With a progress of printing, the memory management unit 40 releases a use region to which used data has been allocated. For example, an allocated use region is released for each page for which print data has been sent to the print mechanism 10.

As illustrated in FIG. 2, an external job-dedicated region 81 to be used for an external job and not to be used for a local job is allocated to the memory region 8. A common region 82 to be used for an external job and a local job is allocated to regions of the memory region except the external job-dedicated region 81. The memory management unit 40 uses, as a method for allocating the external job-dedicated region 81 to the memory region 8, one of three types (A) through (C):

(A) at-stop extension method
(B) at-startup fixing method
(C) at-stop fixing method

The at-stop extension method is a method in which the external job-dedicated region 81 is allocated at start-up, and the allocated size of the external job-dedicated region 81 is extended at stop of printing and is reduced at restart of printing. The at-startup fixing method is a method in which the external job-dedicated region 81 is allocated at start-up, and the allocated size is maintained without change. The at-stop fixing method is a method in which the external job-dedicated region 81 is not allocated and the entire memory region 8 is used as the common region 82 at start-up, and the external job-dedicated region 81 is allocated at stop of printing, and the external job-dedicated region 81 is returned to the common region 82 at restart of printing. Here, “at stop of printing” in the at-stop extension method and the at-stop fixing method refers to the time when printing is suspended in the middle of the printing for some reasons and printing cannot be performed.

As illustrated in FIG. 2, the memory management unit 40 includes an allocation method setting unit 41. Based on a local operation or an online operation, the allocation method setting unit 41 performs setting in which one of the methods (A) through (C) is used to allocate the external job-dedicated region 81. The memory management unit 40 includes a use region allocation unit 42 that performs allocation and release of a use region to be used for a print job (an external job and a local job) to and from the memory region 8 in accordance with a memory acquisition request and a memory release request described alter, an external job-dedicated region allocation unit 43 that allocates the external job-dedicated region 81 to the memory region 8, and a common region allocation unit 44 that allocates the common region 82 to the memory region 8. The external job-dedicated region allocation unit 43 and the common region allocation unit 44 perform allocation in accordance with the allocation method set by the allocation method setting unit 41.

### At-Stop Extension Method

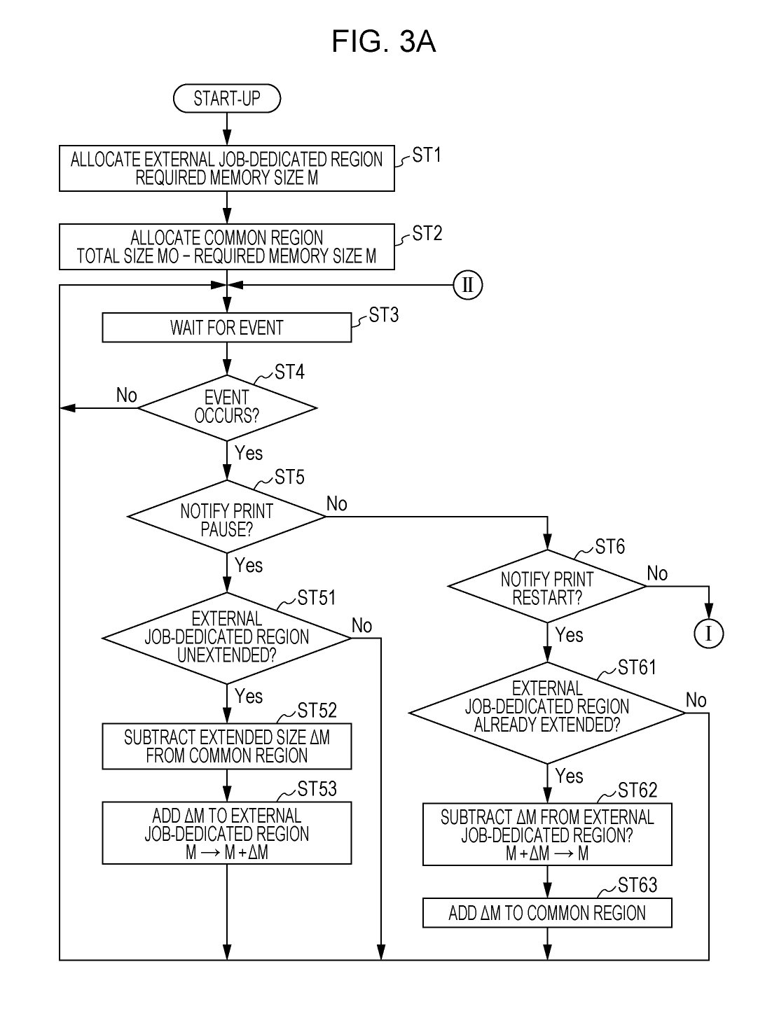

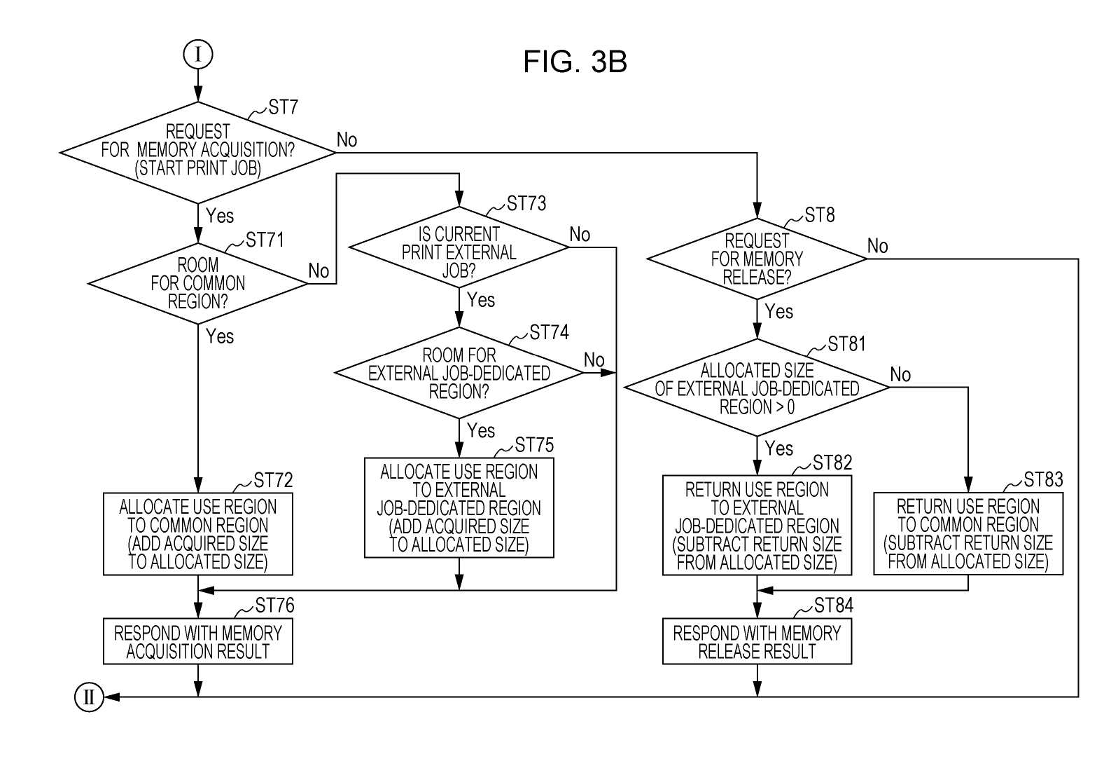

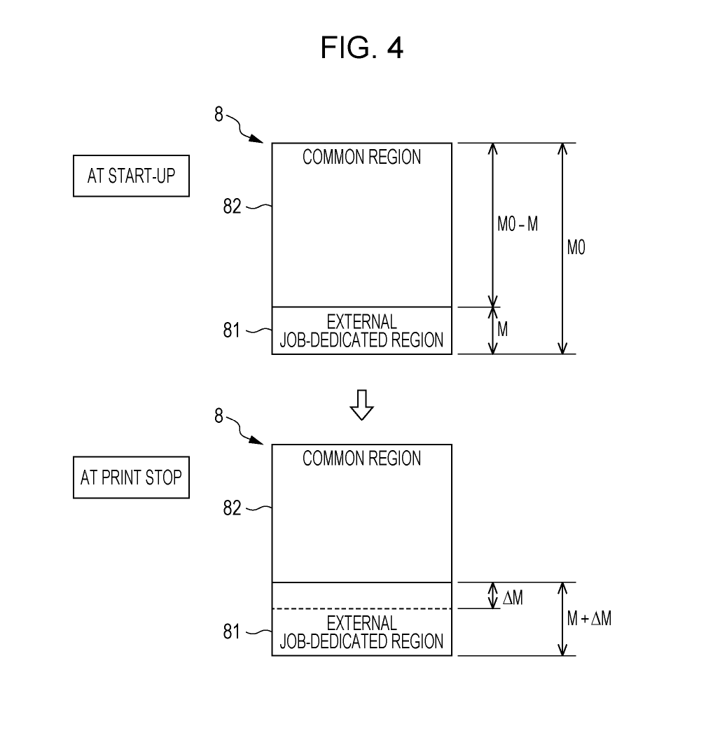

FIGS. 3A and 3B are flowcharts of control of performing allocation of a memory region, and depict control in the case of allocating the external job-dedicated region 81 by the at-stop extension method. FIG. 4 is an illustration of the at-stop extension method. In the at-stop extension method, the external job-dedicated region 81 and the common region 82 are allocated at start-up of the print apparatus 1 (steps ST1 and ST2). For example, at start-up of the print apparatus 1, the external job-dedicated region allocation unit 43 allocates a predetermined required memory size M as the external job-dedicated region 81 (step ST1: external job-dedicated region allocation step). Subsequently, the common region allocation unit 44 allocates, as the common region 82, a size M0-M obtained by subtracting the required memory size M set as the external job-dedicated region 81 from a total size M0 of the memory region 8 (step ST2: common region allocation step).

After setting of the external job-dedicated region 81 and the common region 82, the memory management unit 40 waits for occurrence of a predetermined event (steps ST3 and ST4). That is, the memory management unit 40 waits for a predetermined time at step ST3, and determines whether notification of occurrence of an event is issued or not in step ST4. If notification of an event is not issued (step ST4: No), steps ST3 and ST4 are repeated until notification of occurrence of an event is issued. Notification of occurrence of an event is notification of occurrence of an event in which allocation or release of the memory region 8 is performed. In this embodiment, four types of event occurrence notification (1) through (4) are expected. If event occurrence notification is issued (step ST4: Yes), the memory management unit 40 determines the content of the event at steps ST5 through ST8, and proceeds to a process corresponding to the content of the event.

(1) print stop notification
(2) print restart notification
(3) memory acquisition request (request for acquiring a use region for execution of a print job)
(4) memory release request (release of a use region due to progress or stop, for example, of printing).

### 1. Print Stop Notification

If the event notification is print stop notification (step ST5: Yes), the external job-dedicated region allocation unit 43 performs steps ST51 through ST53 (extension step/part of external job-dedicated region allocation step) to extend the external job-dedicated region 81. In this embodiment, an extension memory size ΔM is previously determined, and is a size in which print job data corresponding to at least one processing unit can be written. For example, the extension memory size ΔM is a size in which print job data corresponding to at least one page can be written. Alternatively, in a case where a plurality of print paper sheets can be fed into the print apparatus 1 beforehand, the extension memory size ΔM may be a size in which print job data corresponding to the number of pages that can be fed beforehand. In a case where the external job-dedicated region 81 is extended, as indicated by “AT PRINT STOP” in FIG. 4, the extended size is M+ΔM.

The required memory size M that is the size of the external job-dedicated region 81 at start-up is set in accordance with the total size M0 of the memory region 8. For example, the required memory size M may be 10% of the total size M0. Alternatively, the size of the extended external job-dedicated region 81 (i.e., required memory size M+extension memory size ΔM) may be set at 10% of the total size M0. That is, the required memory size M may be a size obtained by subtracting the extension memory size ΔM from 10% of the total size M0. The required memory size M may be other sizes except 10% of the total size M0.

The external job-dedicated region allocation unit 43 may determine the size of the external job-dedicated region 81 at start-up or after extension by other methods. For example, in the case of allocating the external job-dedicated region 81 at stop of printing, the size of the external job-dedicated region 81 may be determined based on the number of pages or jobs of external jobs printed after start-up or the number of pages or jobs of external jobs that are being accumulated in the memory region 8. Alternatively, based on history information held in the print apparatus 1, the size of the external job-dedicated region 81 may be determined in accordance with the average or maximum number of pages or the average number of jobs of external jobs fed to the print apparatus 1.

In step ST51, the external job-dedicated region allocation unit 43 determines whether the external job-dedicated region 81 is unextended or not. If the allocated size of the external job-dedicated region 81 is smaller than the extended size (M+ΔM), it is determined that the external job-dedicated region 81 is unextended (step ST51: Yes), and the process proceeds to step ST52. In step ST52, the extension memory size ΔM is subtracted from the size of the common region 82. Subsequently, the process proceeds to step ST53, and the extension memory size ΔM is added to the size of the external job-dedicated region 81. In this manner, the size of the external job-dedicated region 81 is extended to M+ΔM. On the other hand, in step ST51, if the allocated size of the external job-dedicated region 81 coincides with the extended size (M+ΔM) (step ST51: No), no extension is needed, and thus, steps ST52 and ST51 are not performed. Thereafter, the process returns to a wait state for event notification (step ST3).

### 2. Print Restart Notification

If the event notification is not print stop notification (step ST5: No), the process proceeds to step ST6, and it is determined whether the event notification is print restart notification or not. If the event notification is print restart notification (step ST6: Yes), the process proceeds to step ST 61. In this case, the external job-dedicated region allocation unit 43 performs steps ST61 through ST63 (reduction step/part of external job-dedicated region allocation step) to reduce the size of the external job-dedicated region 81.

In step ST61, the external job-dedicated region allocation unit 43 determines whether the external job-dedicated region 81 has been already extended or not. If the allocated size of the external job-dedicated region 81 coincides with the extended size (M+ΔM) (step ST61: Yes), the process proceeds to step ST62, and the extension memory size ΔM is subtracted from the size of the external job-dedicated region 81. The process then proceeds to step ST63, and the extension memory size ΔM is added to the size of the common region 82. In this manner, the size of the external job-dedicated region 81 is reduced to the required memory size M, which is an original size. On the other hand, in step ST61, if the allocated size of the external job-dedicated region 81 is smaller than the extended size (M+ΔM) (step ST61: No), reduction is not needed, and thus, steps ST62 and ST61 are not performed. Thereafter, the process returns to the wait state for event notification (step ST3).

In the manner described above, when printing is suspended because of an error or other reasons, the external job-dedicated region allocation unit 43 extends the allocated size of the external job-dedicated region 81 by a predetermined size ΔM from the set size at start-up. If printing is restarted because of return from an error, for example, the size of the external job-dedicated region 81 is returned to the required memory size M that is the set size at start-up.

### 3. Memory Acquisition Request

If the event notification is not print restart notification (step ST6: No), the process proceeds to step ST7, and it is determined whether the event notification is notification of a memory acquisition request or not. Notification of the memory acquisition request is issued when the print job processing unit 30 executes a new print job, for example. If the event notification is a memory acquisition request (step ST7: Yes), the process proceeds to step ST71. The use region allocation unit 42 performs steps ST71 through ST75 (use region allocation step), thereby allocating a use region depending on whether the print job is a local job or an external job.

In steps ST71 through ST75, in a case where the print job is a local job, the use region allocation unit 42 allocates a use region only to the common region 82. On the other hand, in a case where the print job is an external job, the use region allocation unit 42 allocates a use region to the common region 82 if the common region 82 has a free space, and otherwise, allocates the use region to the external job-dedicated region 81. The use region allocation unit 42 first tries to allocate a use region to the common region 82. To perform this allocation, in step ST71, it is determined whether the common region 82 has a free space corresponding to a processing unit or not. If it is determined that the common region 82 has a free space (step ST71: Yes), the process proceeds to step ST72, and the use region corresponding to the processing unit is allocated to the common region 82. Specifically, a currently acquired size (size corresponding to the processing unit) is added to the allocated size of the common region 82. The process then proceeds to step ST76, and the print job processing unit 30 is notified of a memory acquisition result. That is, the print job processing unit 30 is notified that memory acquisition has succeeded.

In step ST71, if it is determined that the common region 82 does not have a free space corresponding to a processing unit (step ST71: No), the use region allocation unit 42 tries to allocate a use region to the external job-dedicated region 81. To perform this allocation, the process proceeds to step ST73, and it is determined whether the print job is an external job or not. If the print job is not an external job (step ST73: No), the use region allocation unit 42 cannot allocate a use region to the external job-dedicated region 81, and thus, the process proceeds to step ST76, and the print job processing unit 30 is notified of a memory acquisition result. That is, the print job processing unit 30 is notified that memory acquisition has failed.

In step ST73, if it is determined that the print job is an external job (step ST73: Yes), the process proceeds to step ST74, and the use region allocation unit 42 determines whether the external job-dedicated region 81 has a free space corresponding to a processing unit or not. If the external job-dedicated region 81 has a free space (step ST74: Yes), the process proceeds to step ST75, and a use region corresponding to a processing unit is allocated to the external job-dedicated region 81. Specifically, a currently acquired size (size corresponding to the processing unit) is added to the allocated size of the external job-dedicated region 81. The process then proceeds to step ST76, and the print job processing unit 30 is notified of a memory acquisition result. That is, the print job processing unit 30 is notified that memory acquisition has succeeded. The print job processing unit 30 writes job data (e.g., image data) in the acquired use region.

If the external job-dedicated region 81 does not have a free space corresponding to a processing unit (step ST74: No), a use region cannot be allocated to the external job-dedicated region 81. Thus, the process proceeds to step ST76, and the print job processing unit 30 is notified of a memory acquisition result. That is, the print job processing unit 30 is notified that memory acquisition has failed. If memory acquisition has failed, the print job processing unit 30 issues a memory acquisition request again. Until a use region is acquired or acquisition of a use region stops, acquisition of a use region continues to be tried.

### 4. Memory Release Request

If the event notification is not a memory acquisition request (step ST7: No), the process proceeds to step ST8, and it is determined whether the event notification is notification of a memory release request or not. Notification of a memory release request is issued as necessary depending on a progress of printing. For example, when image data written in an acquired use region is read out by the print processing unit 50, converted to print data, and output to the print mechanism 2, the memory management unit 40 is notified of a memory release request of requesting release of this use region. Alternatively, in a case where stop of a print job is requested by a local operation or an online operation, the print job processing unit 30 notifies the memory management unit 40 of a memory release request that requests release of a use region allocated to a print job to be stopped. If the event notification is notification of a memory release request (step ST8: Yes), the process proceeds to step ST81. The use region allocation unit 42 performs steps ST81 through ST83 (release step), thereby releasing the use region.

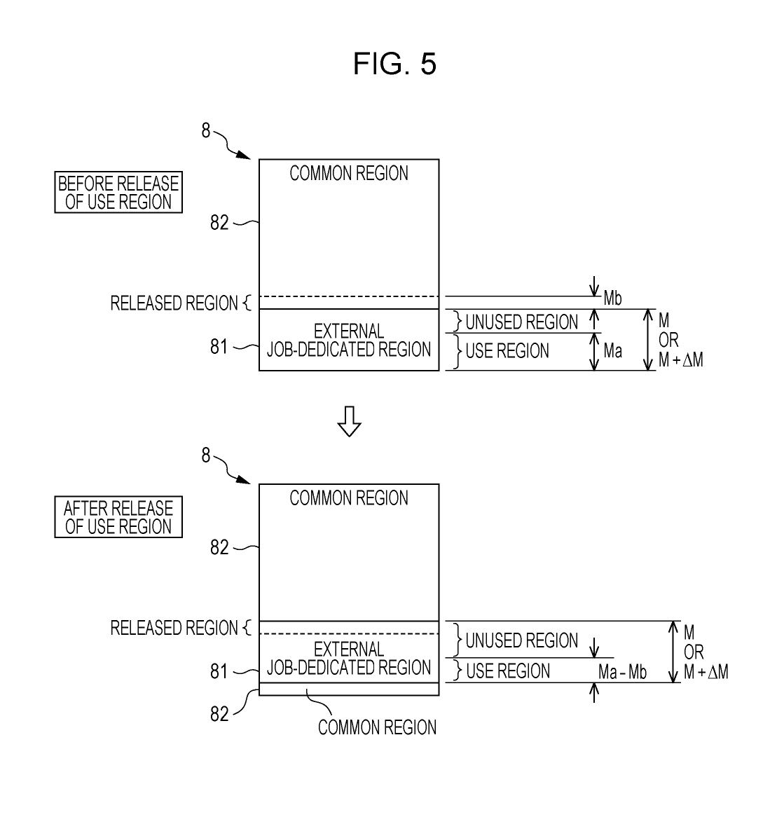

FIG. 5 is an illustration of a method for allocating a use region to be released. The use region to be released is returned (allocated) to the external job-dedicated region 81 or the common region 82, but is returned to the external job-dedicated region 81 if possible. Specifically, a destination to which the use region to be released returns is determined in the following manner. First, in step ST81, the use region allocation unit 42 determines the size of a use region (region in which data has been written) in the external job-dedicated region 81. Specifically, it is determined whether the size of the use region in the external job-dedicated region 81 is larger than 0 (zero) or not. If print job data is written in the external job-dedicated region 81, the size of the use region is larger than 0 (step ST81: Yes). In this case, the process proceeds to step ST82, and the external job-dedicated region 81 is selected as the destination of return of the use region to be released.

In the example indicated by “BEFORE RELEASE OF USE REGION” in FIG. 5, the size of the use region in the external job-dedicated region 81 is Ma. The size of an unused region is M−Ma. If the external job-dedicated region 81 has been already extended, the size of the unused region is M+ΔM−Ma. On the other hand, a return size that is the size of a use region to be currently released (released region) is Mb. In step ST82, the use region allocation unit 42 subtracts the return size Mb from the use region size Ma of the external job-dedicated region 81. In this manner, as indicated by “AFTER RELEASE OF USE REGION” in FIG. 5, the use region size of the external job-dedicated region 81 is Ma−Mb, and the size of the unused region increases by Mb. That is, the use region to be released is returned to the unused region of the external job-dedicated region 81. The use region to be released is returned from the common region 82 in the example illustrated in FIG. 5, but may be similarly returned from the external job-dedicated region 81.

On the other hand, in step ST81, if the size of the use region in the external job-dedicated region 81 is equal to 0 (zero) (step ST81: No), the process proceeds to step ST83. In this case, since the entire external job-dedicated region 81 is unused, the use region to be released cannot be returned to the external job-dedicated region 81. In view of this, in step ST83, the use region allocation unit 42 returns the use region to be released to the common region 82. Thus, in step ST83, the return size Mb that is the size of a use region to be currently released (released region) is subtracted from the use region size of the common region 82. The use region allocation unit 42 selects the external job-dedicated region 81 as the destination of return of the use region to be released in step ST82 or returns the use region to be released to the common region 82 in step ST83. Thereafter, the process proceeds to step ST84. In step ST84, the print job processing unit 30 is notified of a memory release result.

In the manner described above, in the at-stop extension method, the required memory size M is allocated as the external job-dedicated region 81 at start-up, and, when print stop notification is issued, the size of the external job-dedicated region 81 is extended to M+ΔM. Thus, in a case where a print job is introduced and a memory acquisition request is received while printing is suspended, the external job-dedicated region 81 has a free memory corresponding to at least the extension memory size ΔM. Accordingly, print job data of a new external job can be written in the memory region 8 while printing is suspended. As a result, an event that an external job cannot be written in the memory region 8 at all to have execution of the external job waited does not occur.

### At-Startup Fixing Method

Next, the at-startup fixing method will be described. The following description is directed only to aspects different from the at-stop extension method, and the same aspects will not be described again. The at-startup fixing method is the same as the at-stop extension method in that allocation of the external job-dedicated region 81 and the common region 82 is performed at start-up of the print apparatus 1. That is, steps ST1 through ST4 in the flowchart of FIG. 3A are the same as those in the at-stop extension method. On the other hand, in the at-startup fixing method, even with reception of print stop notification and print restart notification, the external job-dedicated region 81 is neither extended nor reduced. Specifically, as depicted in FIG. 3A, in the at-startup fixing method, processes of steps ST5 and ST51 through ST53 and processes of steps ST6 and ST61 through ST63 are not performed. That is, in the at-startup fixing method, the size of the external job-dedicated region 81 is fixed to the predetermined required memory size M, and is fixed in the allocation status indicated by “AT START-UP” in FIG. 4.

In the at-startup fixing method, since the external job-dedicated region 81 is not extended, in performing allocation of a use region in response to a memory acquisition request (i.e., in performing steps ST7 and ST71 through ST76 in FIG. 3B), the size of the external job-dedicated region 81 is always the required memory size M. That is, in the at-stop extension method described above, allocation of a use region to a memory acquisition request during suspension of printing can be performed on the external job-dedicated region 81 having an extended size, whereas, in the at-startup fixing method, a memory acquisition request is always issued to the external job-dedicated region 81 having a size set at start-up.

In the at-startup fixing method, however, the required memory size M is also always obtained as the external job-dedicated region 81, and thus, an external job can be allocated to at least the required memory size M even during suspension of printing. Accordingly, an event that an external job cannot be written in the memory region 8 at all to have execution of the external job waited does not occur.

### At-Stop Fixing Method

The at-stop fixing method will now be described. The following description is directed only to aspects different from the at-stop extension method, and the same aspects will not be described again. The at-stop fixing method is different from the at-stop extension method in that allocation of the external job-dedicated region 81 and the common region 82 is not performed (i.e., steps ST1 and ST2 in the flowchart of FIG. 3A are not performed) at start-up of the print apparatus 1. That is, in the at-stop fixing method, event occurrence notification is kept waiting in a state where the external job-dedicated region 81 is not allocated after start-up of the print apparatus 1.

In a manner similar to the at-stop extension method, in the at-stop fixing method, when the print stop notification is received, the size of the external job-dedicated region 81 is extended by a predetermined size. The extension size may be equal to the extension memory size ΔM of the at-stop extension method, or may be the required memory size M obtained at start-up, for example. Alternatively, the extension size may be other sizes. When print restart notification is received, the external job-dedicated region 81 is reduced by a size equal to the extension size, and the state is returned to a state in which the external job-dedicated region 81 is not allocated.

In a manner similar to the at-stop extension method, in the at-stop fixing method, in a case where a print job is introduced and a memory acquisition request is received during suspension of printing, a predetermined amount of a region to which an external job can be allocated is obtained. Thus, in a manner similar to the at-stop extension method, print job data of an external job is additionally written in the memory region 8 during suspension of printing. Thus, an event that an external job cannot be written in the memory region 8 at all to have execution of the external job waited is less likely to occur.

### Main Advantages of Embodiment

As described above, in the print apparatus 1 and the memory managing method for the print apparatus 1 according to this embodiment, the external job-dedicated region 81 that is used for an external job and is not used for a local job can be allocated to the memory region 8. Thus, even when the local job cannot be accepted any more, the external job can be accepted separately. Accordingly, even when processing of a print job is suspended, waiting of execution of the external job can be avoided. For example, if the external job can be accepted, the external job can be selected as a target of change of the print order. As a result, the external job can be printed with priority by changing the print order. In addition, the external job can be accepted before the local job is canceled to create a free space in the memory region. Thus, when the local job is canceled, the already accepted external job can be immediately executed. As a result, waiting of execution of the external job can be avoided.

In this embodiment, in allocating use regions for an external job and a local job to the memory region 8, the use region for the external job is allocated to the common region 82 if the common region 82 has a free space, and is allocated to the external job-dedicated region 81 if the common region 82 does not have a free space. The use region for the local job is allocated to the common region 82 and is not allocated to the external job-dedicated region 81. Accordingly, shortage of a free space does not occur in the external job-dedicated region 81 before occurrence of shortage of a free space in the common region 82. Thus, shortage of a free space does not occur in the memory region 8 without acceptance of any external job. As a result, waiting of execution of the external job can be avoided.

In this embodiment, in releasing the use region for an external job and the use region for a local job, if the external job-dedicated region 81 has an allocated use region, a use region to be released is allocated to the external job-dedicated region 81, and, if the external job-dedicated region 81 does not have an allocated use region, the use region to be released is allocated to the common region 82. In the manner described above, the use region to be released is returned (allocated) to the external job-dedicated region 81 with priority, so that an unused region of the external job-dedicated region can be kept as large as possible. Accordingly, an external job can be accepted, and waiting of execution of the external job can be avoided.

In this embodiment, in allocating the external job-dedicated region 81 to the memory region 8 at start-up, the method of maintaining the allocation size (at-startup fixing method) and the method of extending the allocation size by a predetermined amount if printing stops in the middle of the printing (at-stop extension method) can be employed. Alternatively, there may be employed a method of allocating the external job-dedicated region 81 to the memory region 8 in a case where printing stops in the middle of the printing without allocation of the external job-dedicated region 81 to the memory region 8 at start-up (at-stop fixing method). In any of the cases, the external job-dedicated region 81 can be obtained at least at stop of printing, and thus, there is little risk of occurrence of shortage of a free space in the memory region without acceptance of any external job. As a result, waiting of execution of the external job can be avoided.

In the at-startup fixing method and the at-stop extension method, the external job-dedicated region 81 is allocated to the memory region 8 at start-up, and thus, the external job-dedicated region 81 can be obtained from start-up. Accordingly, the external job-dedicated region 81 can be obtained without fail. In addition, in the at-stop extension method, when printing stops in the middle of the printing, the external job-dedicated region 81 is further extended, and thus, an external job can be additionally accepted during the stop. As a result, waiting of execution of the external job can be avoided. On the other hand, in the at-startup fixing method, even when printing stops in the middle of the printing, the external job-dedicated region 81 is not extended, but, since the external job-dedicated region 81 is obtained at start-up, there is no risk of shortage of a free space in the memory region without acceptance of any external job. As a result, waiting of execution of the external job can be avoided.

On the other hand, in the at-stop fixing method, the external job-dedicated region 81 is not allocated at start-up, and the external job-dedicated region 81 is allocated at stop of printing. Thus, a larger amount of local jobs can be accepted until printing stops. Thus, there is a small risk of a failure in accepting a local job.

In the at-stop extension method and the at-stop fixing method, when suspended printing restarts, the size of the external job-dedicated region 81 extended at the stop of printing can be reduced to a size before extension when suspended printing restarts. Thus, an unnecessarily large memory region is not allocated to the external job-dedicated region 81.

In this embodiment, the method of allocating the external job-dedicated region 81 to the memory region can be set to any one of the at-startup fixing method, the at-stop extension method, and the at-stop fixing method. Accordingly, a user can select an allocation method as appropriate depending on an introduction status of an external job and a local job, for example.

In this embodiment, the external job-dedicated region 81 of a size in accordance with the total size of the memory region 8 is allocated. In this manner, in a case where the size of the memory region 8 is large, a large size of the external job-dedicated region 81 can be obtained, so that a large amount of external jobs can be accepted. Accordingly, printing of an external job can be kept waiting. In addition, in a case where the size of the external job-dedicated region 81 is determined based on the number of pages or jobs of external jobs accepted from start-up to stop of printing or the number of pages or jobs of external jobs that are being accumulated in the memory region 8, the size of the external job-dedicated region 81 can be set in accordance with the introduction status of a print job. As a result, waiting of a print job having a large amount of instruction can be avoided.

### Other Embodiments

In the embodiment described above, the invention is applied to the memory managing method for managing allocation of the memory region 8 to be used for a print job. The invention, however, is applicable to management of a memory region to be used for a job except the print job or a memory job to be used for both a print job and another job.

The entire disclosure of Japanese Patent Application No.2017-016533, filed Feb. 1, 2017, is expressly incorporated by reference herein.

What is claimed is:

1. A print apparatus comprising: a memory region usable for an external job by an online operation and a local job by a local operation; and a memory management unit that manages allocation of the memory region, wherein
the memory management unit includes
an external job-dedicated region allocation unit that allocates, to the memory region, an external job-dedicated region to be used for the external job and not to be used for the local job, and
a common region allocation unit that allocates a common region to be used for the external job and the local job to a part of the memory region except the external job-dedicated region.

2. The print apparatus according to claim 1, wherein
the memory management unit includes a use region allocation unit that allocates use regions for the external job and the local job to the memory region, and
the use region allocation unit
allocates the use region for the external job to the common region if the common region has a free space and to the external job-dedicated region if the common region has no free space, and
allocates the use region for the local job to the common region and does not allocate the use region for the local job to the external job-dedicated region.

3. The print apparatus according to claim 2, wherein, in releasing the use region for the external job or the use region for the local job, if the external job-dedicated region has an allocated use region, the use region allocation unit allocates a use region to be released to the external job-dedicated region, and, if the external job-dedicated region has no allocated use region, the use region allocation unit allocates the use region to be released to the common region.

4. The print apparatus according to claim 1, wherein the external job-dedicated region allocation unit allocates the external job-dedicated region to the memory region at start-up.

5. The print apparatus according to claim 1, wherein, in a case where printing stops in a middle of the printing, the external job-dedicated region allocation unit extends the external job-dedicated region.

6. The print apparatus according to claim 5, wherein, in a case where the printing that has stopped in the middle of the printing restarts, the external job-dedicated region allocation unit reduces the external job-dedicated region.

7. The print apparatus according to claim 4, wherein, in a case where printing stops in a middle of the printing, the external job-dedicated region allocation unit does not extend the external job-dedicated region.

8. The print apparatus according to claim 1, wherein, in a case where printing stops in a middle of the printing, the external job-dedicated region allocation unit allocates the external job-dedicated region to the memory region.

9. The print apparatus according to claim 1, wherein the memory management unit includes an allocation method setting unit that sets a method of allocating the external job-dedicated region to the memory region as one of an at-startup fixing method of allocating the external job-dedicated region at start-up, an at-stop fixing method of allocating the external job-dedicated region in a case where printing stops in a middle of the printing, and an at-stop extension method of allocating the external job-dedicated region at start-up and extending the external job-dedicated region in a case where printing stops in a middle of the printing.

10. The print apparatus according to claim 1, wherein the external job-dedicated region allocation unit allocates the external job-dedicated region of a size in accordance with a size of the memory region.

11. The print apparatus according to claim 1, wherein the external job-dedicated region allocation unit allocates the external job-dedicated region of a size in accordance with the number of pages of the external job.

12. The print apparatus according to claim 1, wherein the external job-dedicated region allocation unit allocates the external job-dedicated region of a size in accordance with the number of jobs of the external job.

13. A memory managing method for a print apparatus that manages allocation of a memory region usable for an external job by an online operation and a local job by a local operation, the method comprising:
allocating, to the memory region, an external job-dedicated region to be used for the external job and not to be used for the local job; and
allocating a common region to be used for the external job and the local job to a part of the memory region except the external job-dedicated region.

14. The memory managing method according to claim 13, further comprising allocating use regions for the external job and the local job to the memory region, wherein
in the allocating of the use regions,
the use region for the external job is allocated to the common region if the common region has a free space, and is allocated to the external job-dedicated region if the common region has no free space, and
the use region for the local job is allocated to the common region and is not allocated to the external job-dedicated region.

15. The memory managing method according to claim 14, further comprising releasing the use region for the external job or the use region for the local job, wherein
in the releasing, if the external job-dedicated region has an allocated use region, a use region to be released is allocated to the external job-dedicated region, and, if the external job-dedicated region has no allocated use region, the use region to be released is allocated to the common region.

16. The memory managing method according to claim 13, wherein the allocating of the external job-dedicated region is performed at start-up.

17. The memory managing method according to claim 13, wherein the allocating of the external job-dedicated region includes extending the external job-dedicated region in a case where printing stops in a middle of the printing.

18. The memory managing method according to claim 17, wherein the allocating of the external job-dedicated region includes reducing the external job-dedicated region in a case where the printing that has stopped in the middle of the printing restarts.

19. The memory managing method according to claim 16, wherein, in a case where printing stops in a middle of the printing, the external job-dedicated region is not extended.

20. The memory managing method according to claim 13, wherein the allocating of the external job-dedicated region is performed in a case where printing stops in a middle of the printing.
